(19) United States
(12) Patent Application Publication
(10) Pub. No.: US 2025/0375945 A1
(43) Pub. Date: Dec. 11, 2025

(54) METHOD OF MANUFACTURING A WORKPIECE MADE FROM A THERMOPLASTIC MATERIAL REINFORCED WITH FIBERS

(71) Applicant: SKF Aerospace France S.A.S, Perrigny (FR)

(72) Inventors: Anthony Roger Jeannot JÉRÔME, TOURNON-SUR-RHONE (FR); Eric Jean-Marie DENEUX, Metz (FR); Nicolas Gabriel Pierre LEBOSSÉ, Viry (FR); Florian Vincent BARDY, Perrigny (FR); Stéphane LEBERCHE, Commenailles (FR); Florent Denis FAUCHERY, Montmeyran (FR)

(21) Appl. No.: 19/220,232

(22) Filed: May 28, 2025

(30) Foreign Application Priority Data
Jun. 6, 2024 (FR) 2405943

(51) Int. Cl. B29C 70/54; B29C 65/00; B29C 65/08; B29C 70/30; B29C 70/84

(52) U.S. Cl. CPC B29C 70/545; B29C 65/08; B29C 66/721; B29C 70/30; B29C 70/84; B29C 2793/0009; B29C 2793/0072; B29C 2793/009

(57) ABSTRACT

A method of manufacturing at least one workpiece having at least locally a rounded shape and/or an angle and which is formed from a thermoplastic material reinforced with fibers includes: at least one step of winding at least one fiber which is pre-impregnated with a thermoplastic material around a mandrel in order to form on the mandrel a lay-up including a wound layer of fibers or a plurality of wound and superimposed layers of fibers; at least one step of cutting out the lay-up formed; and at least one step of removing from the mandrel the cut-out lay-up.

### CROSS-REFERENCE

This application claims priority to French patent application no. 2405943 filed on Jun. 6, 2024, the contents of which are fully incorporated herein by reference.

### BACKGROUND OF THE INVENTION

The present invention generally relates to material manufacturing, and more particularly to methods of manufacturing workpieces made from a composite material comprising a thermoplastic material reinforced with fibers, specifically workpieces having an at least locally a rounded shape and/or an angle such as a fitting used to connect at least two members.

The use of a fitting formed from composite material, in particular from a thermoplastic material reinforced with fibers, such as glass or carbon fibers, is particularly advantageous for replacing metal fittings for fields in which the weight saving is essential, such as for example in aeronautics.

Specific types of fittings have at least locally complex shapes, being rounded and/or including an angle.

It is known to manufacture these fittings from sheets which are formed by a flat stack of layers of fibers which are connected by a thermoplastic material.

The sheets are deformed and assembled in order to produce a preform. Specific portions of the sheets are pleated, folded or cut out and displaced in order to form the rounded portions and the angles of the fitting to be manufactured.

However, the pleating of the sheets for producing non-unfolding, rounded or angular shapes according to such a manufacturing method involves mechanical weaknesses, which greatly impairs the performance levels of the fitting by reducing the mechanical strength properties.

Furthermore, the correct arrangement of the material of the sheets of the rounded portions and the angles in order to form the preform remains complex, which limits manufacturability.

### SUMMARY OF THE INVENTION

Therefore, an object of the invention is to overcome these disadvantages and to provide a simple method for manufacturing a workpiece, such as a fitting, made of a thermoplastic material reinforced by fibers and comprising non-unfolding complex portions, which conserves the mechanical properties of the workpiece.

As such, the present invention is directed to a method for manufacturing one or more workpieces which comprise at least locally a rounded shape and/or an angle and which are formed from a thermoplastic material reinforced with fibers, characterized in that it comprises the following successive steps:
at least one step of winding at least one fiber which is pre-impregnated with a thermoplastic material around a mandrel in order to form on the mandrel a lay-up comprising a wound layer of fibers or a plurality of wound and superimposed layers of fibers;
at least one step of cutting out the lay-up formed; and
at least one step of removing from the mandrel the cut-out lay-up,

In one embodiment, the workpiece to be manufactured is obtained directly from the cut-out lay-up.

In another embodiment, the manufacturing method comprises one or more preforms of the workpiece to be manufactured being obtained from the cut-out lay-up and further comprises a step of inserting one or more of the preforms inside a mold and of over-molding from a thermoplastic material.

For process reasons, the cut-out lay-up or preform may have a slightly different shape from the shape of the final workpiece to be manufactured, the over-molding step in the mold may allow the desired, final shape to be obtained.

In one embodiment, the manufacturing method may comprise a plurality of winding steps, a plurality of cut-out steps for the formed lay-ups, a plurality of steps of removing from the mandrel one or more preforms of the workpiece to be manufactured from each cut-out lay-up, the manufacturing method further comprising a step of superimposing a plurality of preforms obtained, the over-molding step being carried out on the superimposition of preforms.

In one embodiment, the step of cutting out the lay-up can lead to the production of two identical workpieces during the step of removal from the mandrel.

Preferably, the step of winding the fiber around the mandrel is controlled by computer.

Advantageously, the step of winding can be assisted by laser heating in order to maintain the thermoplastic material of the pre-impregnated fiber in the liquid state.

Preferably, the fiber is wound around the mandrel so as to form a plurality of angles relative to the axis of the mandrel.

For example, the material of the fibers wound around the mandrel can be selected from: carbon, glass, Kevlar® or a mixture of such materials.

Advantageously, a plurality of cut-out lay-ups or a plurality of preforms can be connected by a welding step, such as a step of ultrasonic welding.

According to an alternative, a plurality of cut-out lay-ups or a plurality of preforms can be connected by a step of consolidation by heating. The heating allows the thermoplastic material to be melted again. The different heated cut-out lay-ups or the different heated preforms to be assembled are connected to each other during the cooling of the thermoplastic material.

The invention also relates to a fitting made of composite material which is manufactured by carrying out the manufacturing method as described above.

### BRIEF DESCRIPTION OF THE SEVERAL VIEWS OF THE DRAWINGS

Further aims, advantages and features will become apparent from the following description, which is given purely by way of illustration and with reference to the appended drawings, in which:

FIG. 1 illustrates a first fitting to be manufactured;

FIG. 2 is a flow chart illustrating the steps of a manufacturing method for the first fitting illustrated in FIG. 1 according to an exemplary embodiment of the invention;

FIG. 3A, FIG. 3B, FIG. 3C, FIG. 3D and FIG. 3E are schematic, perspective views of the first fitting illustrated in FIG. 1 at different steps of the manufacture according to an exemplary embodiment of the manufacturing method of the invention;

FIG. 4 illustrates a second fitting to be manufactured;

FIG. 5 is a flow chart illustrating the steps of a manufacturing method for the second fitting illustrated in FIG. 4 according to an exemplary embodiment of the invention; and

FIG. 6A and FIG. 6B show schematic, perspective views of the second fitting illustrated in FIG. 4 at different steps of its manufacture according to an exemplary embodiment of the manufacturing method of the invention.

### DETAILED DESCRIPTION OF THE INVENTION

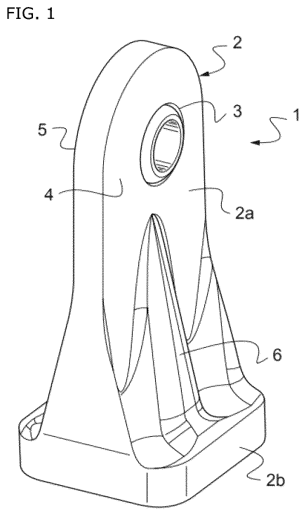

FIG. 1 illustrates a first exemplary embodiment of a workpiece 1 to be manufactured by the present method. Preferably, the workpiece 1 to be manufactured is a T-shaped fitting which is used to connect two ball joint members which move relative to each other, in particular which are intended to be used in the field of aeronautics.

As described below, the fitting according to the first exemplary embodiment is called the “first fitting”.

The first fitting 1 comprises a body 2. The body 2 comprises a first portion 2a which is also referred to as the web and a second portion 2b which is in the form of a base and which comprises a fixing zone for the first member to be connected.

The first portion 2a comprises a through-hole 3 which is arranged near an upper end and which is intended to receive a ball joint. The first portion 2a and the second portion 2b are monobloc and extend in accordance with substantially perpendicular geometric planes, respectively.

The term “substantially perpendicular” as used in the present disclosure is intended to mean that an angle which is formed between the two geometric planes is included within a range from 60° to 90°.

The web 2a comprises here first and second opposite main faces 4 and 5. The two main faces 4, 5 are substantially parallel and diverge in a direction away from each other in a lower portion of the web until moving into contact with the base.

The first fitting 1 illustrated comprises two complex portions, each one constituted by a boss 6. A first boss 6 extends at the joint of the first face 4 and the base 2b and a second similar boss 6 extends at the joint between the second face 5 and the base 2b. These bosses 6 provide an undulating or “wave-like” appearance for the body 2 and increase the rigidity of the first fitting 1.

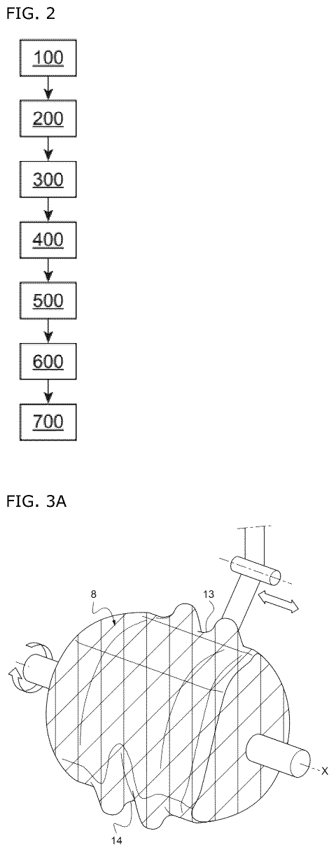

A first exemplary embodiment of the manufacturing method according to the invention, which is intended to manufacture the first fitting 1 from a composite material formed from thermoplastic material reinforced with fibers, is described with reference to the flow chart of FIG. 2.

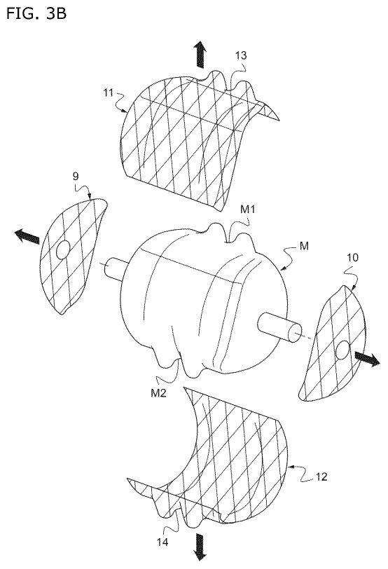

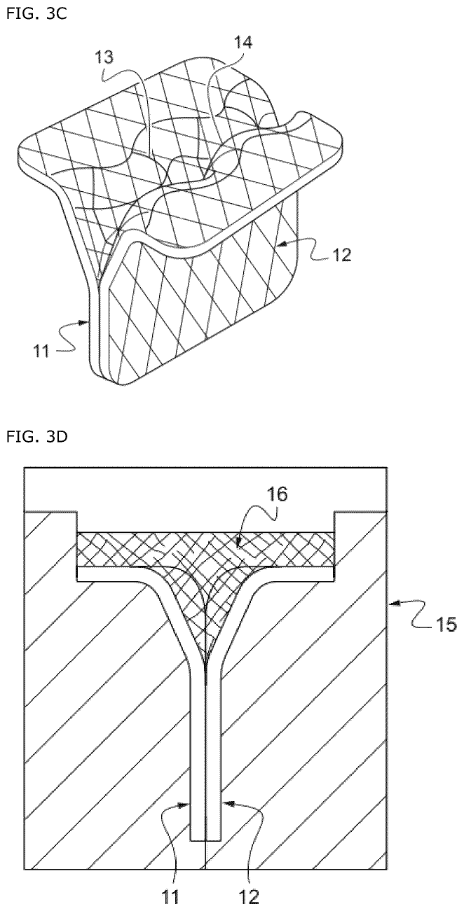

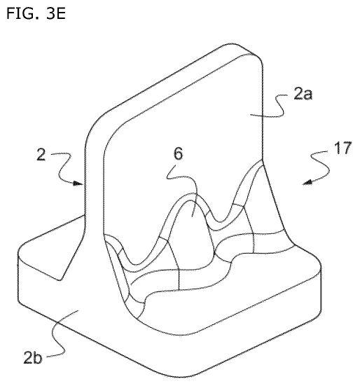

As illustrated in FIG. 3A, during a step 100, one or more pre-impregnated fibers made of a thermoplastic material are wound around a mandrel M in order to form, on the mandrel M, a lay-up 8 constituted by a plurality of layers of fibers which are wound and superimposed one on the other. In a variant, the lay-up 8 may comprise a single layer of wound fibers.

In the exemplary embodiment illustrated, a fiber in the form of a band is wound around the mandrel M.

According to an alternative, several fibers may be wound simultaneously around the mandrel M.

Each fiber is initially pre-wound on a head.

In order to carry out the filament winding, the mandrel M is rotated about the axis X thereof.

A sub-step of the initial winding of the pre-impregnated fibers around the mandrel M allows a first layer to be formed around the mandrel M. This first layer is formed with the rotation of the mandrel M around the axis X thereof and the displacement of the heads which support the fibers parallel with the axis X.

Subsequently, a succession of sub-steps of winding the fibers allows the lay-up 8 to be formed by superimposition of layers one on the other around the mandrel M.

According to an alternative, the lay-up 8 may be constituted or formed by a single layer of wound fibers.

Advantageously, the step 100 of winding the fibers around the mandrel M may be controlled by computer and thus automated.

Preferably, each fiber is wound around the mandrel M so as to advantageously form a plurality of angles relative to the axis X of the mandrel M in order to improve the final properties of mechanical strength of the first fitting 1 manufactured. Preferably, the angle varies between 0 and 90°.

For example, for the same layer of fibers, the angle formed relative to the axis X of the mandrel M may be substantially constant plus or minus 5° and for each new layer the angle formed relative to the axis X of the mandrel M for this new layer may be different from the angle of the preceding layer while being substantially constant plus or minus 5° during the formation of this new layer.

For example, the fibers may be glass fibers, carbon fibers, Kevlar® fibers, a mixture of such fibers, or any other suitable material.

The thermoplastic material is, for example, selected from the following materials: PEEK, PEKK, PPS, PEAK or any other suitable material.

With reference to FIGS. 3A and 3B, in this first exemplary embodiment the mandrel M has an outer surface which includes first and second grooves M1 and M2 which are radially opposite and intended to form first and second grooves 13 and 14 on the lay-up 8 and the first and second bosses 6 of the first fitting 1 to be manufactured.

In a step 200, the lay-up 8 obtained at the end of the step 100 of filament winding is cut out.

The number of cut-outs may vary as a function of the number and the shape of the preforms to be obtained for the manufacture of the desired workpiece to be manufactured.

As illustrated in FIG. 3B, in the first exemplary embodiment illustrated, four cut-outs are carried out on the lay-up 8. However, the number of cut-outs may be different and include any appropriate, desired number of cut-outs.

Subsequently, in a step 300, the cut-out portions of the lay-up 8 are removed from the mandrel M in order to obtain the workpiece to be manufactured, which is the first fitting in this first exemplary embodiment illustrated.

The first and second ends 9 and 10 of the lay-up 8 are removed via two cut-outs which are formed in a plane perpendicular to the axis of the mandrel M and are not used.

Two other cut-outs are formed in two different planes which are parallel with the axis X of the mandrel M so as to obtain identical or substantially identical first and second central portions, which form substantially identical first and second preforms 11 and 12, respectively.

Each one of the first and second preforms 11 and 12 includes one of the first and second grooves 13 and 14.

As can be seen in FIG. 3C, the first and second opposite main faces are each formed from one of the preforms, which are obtained in this manner from the common lay-up 8 formed in the step 100 of filament winding, and positioned one against the other.

In the exemplary embodiment illustrated with reference to FIG. 3D, the first and second preforms 11 and 12 are subsequently positioned inside a mold 15 in order to carry out an additional over-molding step 500, also referred to as injection-molding. The over-molding is carried out from a thermoplastic material.

Preferably, the over-molding is carried out from a thermoplastic material which is identical to the thermoplastic material of the pre-impregnated fibers used for the step 100 of filament winding around the mandrel M. The thermoplastic material may be, for example, reinforced by fibers.

In the exemplary embodiment illustrated, thermoplastic material 16 reinforced with fibers is added by over-molding to the first and second preforms 11 and 12 so as to connect the first and second preforms 11 and 12 and to form the base 2b of the first fitting 1.

According to an alternative to the over-molding step 500, the first and second preforms 11 can be connected by a welding step, such as an ultrasonic welding step.

After the over-molding step, the workpiece 17 obtained or formed, as illustrated in FIG. 3E, is removed from the mold 15 in a step 600.

According to embodiments, the step 600 of removal can be followed by optional steps 700 of finishing the workpiece 17, for example, steps of machining and/or polishing and/or surface treatment and application of a coating and/or inserting a trunnion in order to obtain the first fitting 1, as illustrated in FIG. 1.

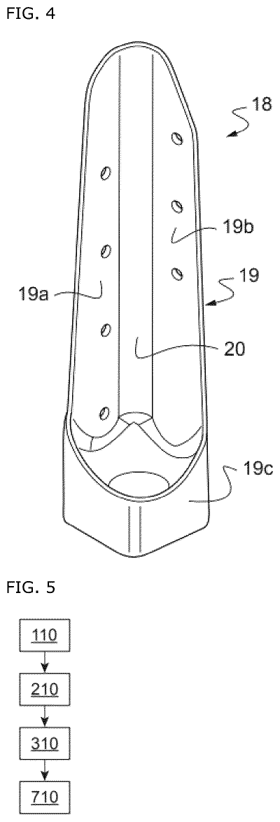

FIG. 4 illustrates a second embodiment of a workpiece to be manufactured. The workpiece to be manufactured is a fitting, commonly referred to as a “corner fitting”, which serves to join, reinforce and rigidify three planes together, and which is in particular intended to be used in the field of aeronautics.

As discussed below, the fitting according to the second embodiment is referred to as the “second fitting”.

The second fitting 18 comprises a body 19. The body 19 comprises a first portion 19a, a second portion 19b and a third portion 19c, which are monobloc and which extend in different geometric planes, respectively.

The first and second portions 19a and 19b form two wings, the joint of which forms a bending line 20 and extends in two substantially perpendicular planes.

The third portion 19c extends in a plane which is substantially perpendicular to the plane of the first portion 19a and substantially perpendicular to the plane of the second portion 19b and extends from a first end of the first portion 19a as far as a first end of the second portion 19b.

The outer face of each of the first portion 19a, second portion 19b and third portion 19c forms a connection zone with one of the three planes of an assembly, in which the second fitting 18 is intended to be fixed.

A second exemplary embodiment of the manufacturing method according to the invention which is intended for the simultaneous manufacture of two second fittings 18, which are each made of composite material and which are formed from thermoplastic material reinforced with fibers, is described with reference to the flow chart of FIG. 5.

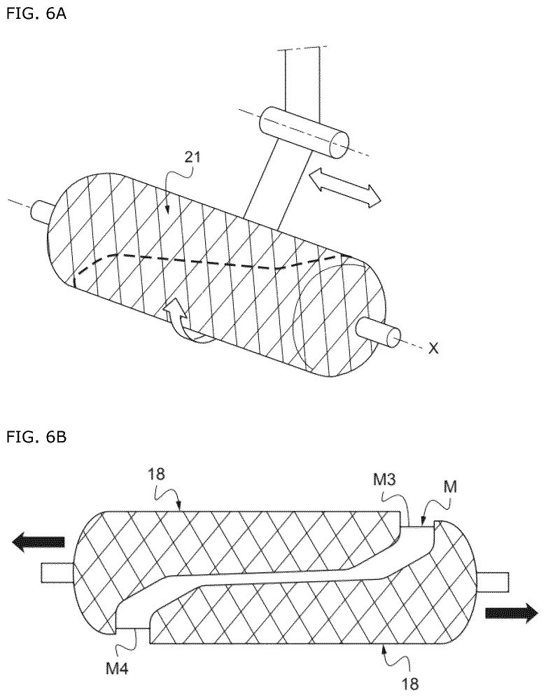

As illustrated in FIG. 6A, during a step 110, one or more pre-impregnated fibers made of a thermoplastic material are wound around a mandrel M in order to form, on the mandrel M, a lay-up 21 constituted or formed by a plurality of layers of fibers which are wound and superimposed one on the other.

In the exemplary embodiment illustrated, a fiber in the form of a band is wound around the mandrel M.

According to an alternative, several fibers may be wound simultaneously around the mandrel M.

Each fiber is initially pre-wound on a head.

In order to carry out the filament winding, the mandrel M is rotated about the axis X thereof.

A sub-step of initial winding of the pre-impregnated fibers around the mandrel M allows a first layer to be formed around the mandrel M. This first layer is formed with the rotation of the mandrel M around the axis X thereof and the displacement of the fibers parallel with the axis X.

Subsequently, a succession of sub-steps of winding the fibers allows the lay-up 21 to be formed by superimposition of layers, one on the other, around the mandrel M.

According to an alternative, the lay-up 21 may be constituted or formed by a single layer of wound fibers.

Advantageously, the step 110 of winding the fibers around the mandrel M may be controlled by computer and thus automated.

Preferably, each fiber is wound around the mandrel M so as to advantageously form a plurality of angles relative to the axis X of the mandrel M in order to improve the final properties of mechanical strength of the second fitting 1 manufactured. Preferably, the angle varies between 0 and 90°.

For example, for the same layer of fibers, the angle formed relative to the axis X of the mandrel M may be substantially constant plus or minus 5° and for each new layer the angle formed relative to the axis X of the mandrel M for this new layer may be different from the angle of the preceding layer while being substantially constant plus or minus 5° during the formation of this new layer.

For example, the fibers may be glass fibers, carbon fibers, Kevlar® fibers, a mixture of these fibers or any other suitable material.

With reference to FIGS. 6A and 6B, in this second exemplary embodiment the mandrel M has first and second angular portions M3 and M4 which are radially opposite and which extend axially between the two ends of the mandrel M, each being intended to form a bending line of one of the two second fittings 18 to be manufactured.

In a step 210, the lay-up 21 obtained at the end of the step 110 of filament winding is cut out.

As illustrated in FIG. 6B, in the second embodiment illustrated, a single cut-out is carried out on the lay-up 21. However, the number of cut-outs may be different and include any appropriate, desired number of cut-outs.

Subsequently, in a step 310, the cut-out portions of the lay-up 21 are removed from the mandrel M in order to obtain the workpieces to be manufactured, which are the two second fittings 18 in this second exemplary embodiment illustrated.

The cut-out is carried out in a plane which is oblique relative to the axis X of the mandrel M so as to obtain two second substantially identical fittings 18 from the common lay-up 21.

According to embodiments, the step 210 of cutting out can be followed by optional steps 610 of finishing the second fittings 18, for example, steps of machining and/or polishing and/or adding material and/or surface treatment and application of a coating.

In another embodiment, the manufacturing method may comprise a plurality of winding steps 100, 110 each comprising the winding of one or more fibers pre-impregnated with a thermoplastic material around the mandrel M. The lay-up 8, 21 which is formed at the end of each winding step is cut out and removed from the mandrel M in order to obtain several preforms. Alternatively, the plurality of winding steps 100, 110 can be carried out on several different mandrels.

The manufacturing method also comprises a step of superimposing a plurality of preforms which are obtained at the end of different winding steps. The over-molding step 500 is thus carried out on the obtained superimposition of preforms inside the mold 15.

The first and second fittings 1, 18 which are obtained according to the first and second embodiments are only examples of a workpiece to be manufactured according to the manufacturing method of the present invention, and other forms or configurations are possible without departing from the scope of the present invention.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A method of manufacturing one or more workpieces which include at least locally a rounded shape and/or an angle and are formed from a thermoplastic material reinforced with fibers, the method comprising:
at least one step of winding at least one fiber which is pre-impregnated with a thermoplastic material around a mandrel so as to form on the mandrel a lay-up including a wound layer of fibers or a plurality of wound and superimposed layers of fibers;
at least one step of cutting out the formed lay-up; and
at least one step of removing the cut-out lay-up from the mandrel.

2. The method according to claim 1, wherein the at least one workpiece to be manufactured is obtained directly from the cut-out lay-up.

3. The method according to claim 1, wherein:
the step of cutting out the formed lay-up includes providing one or more preforms of the workpiece to be manufactured from the cut-out lay-up; and
the method further comprises a step of inserting the one or more of the preforms inside a mold and a step of over-molding a thermoplastic material.

4. The method according to claim 3, wherein:
the at least one step of winding the at least one fiber includes a plurality of winding steps so as to form a plurality of lay-ups;
the at least one step of cutting out the formed lay-up includes a plurality of cut-out steps for the plurality of formed lay-ups;
the at least one step of removing the cut-out lay-up from the mandrel includes a plurality of steps of removing from the mandrel one or more preforms of the workpiece to be manufactured from each cut-out lay-up;
the method further comprises a step of superimposing the plurality of preforms; and
the step of over-molding a thermoplastic material is carried out on the superimposition of preforms.

5. The method according to claim 1, further comprising a step of connecting a plurality of cut-out lay-ups or a plurality of preforms by welding.

6. The method according to claim 5, wherein the step of connecting includes ultrasonic welding.

7. The method according to claim 1, wherein the at least one step of cutting out the lay-up forms two identical workpieces during the step of removal from the mandrel.

8. The method according to claim 1, wherein the at least one step of winding is assisted by laser heating to maintain the thermoplastic material of the pre-impregnated fiber in a liquid state.

9. The method according to claim 1, wherein the fiber is wound around the mandrel so as to form a plurality of angles relative to an axis of the mandrel.

10. The method according to claim 1, wherein the material of the fibers wound around the mandrel (M) is selected from carbon, glass, Kevlar® or a mixture of at least two of carbon, glass and Kevlar®.

11. A fitting made of composite material manufactured by the manufacturing method according to claim 1.
